(19) United States
(12) Patent Application Publication
(10) Pub. No.: US 2010/0157220 A1
(43) Pub. Date: Jun. 24, 2010

(54) Display Substrate, Liquid Crystal Display Device Having the Display Substrate and Method of Manufacturing the Display Substrate

(76) Inventors: Kyoung-Ju Shin, Hwaseong-si (KR); Chong-Chul Chai, Seoul (KR); Mae-Hye Jung, Suwon-si (KR)

Correspondence Address: F. CHAU & ASSOCIATES, LLC, 130 WOODBURY ROAD, WOODBURY, NY, 11797, US

(21) Appl. No.: 12/492,673

(22) Filed: Jun. 26, 2009

(30) Foreign Application Priority Data
Dec. 19, 2008 (KR) 2008-129756

(51) Int. Cl. G02F 1/1337; G02F 1/1333; G02F 1/13

(52) U.S. Cl. 349/123; 349/138; 349/187

(57) ABSTRACT

A display substrate includes a lower base substrate, an organic insulation layer, an insulation protrusion, a pixel electrode and a lower alignment layer. The lower base substrate comprises a plurality of unit pixel areas, the plurality of unit pixel areas being divided into a plurality of sub-pixel areas arranged in a matrix pattern. An organic insulation layer is formed on the lower base substrate. An insulation protrusion is formed on the organic insulation layer corresponding to a boundary of sub-pixel areas. A pixel electrode is formed on the organic insulation layer and the insulation protrusion. In addition, the lower alignment layer is formed on the pixel electrode and irradiated with ultraviolet (UV) light to provide different alignment directions that correspond to the sub-pixel areas.

### PRIORITY STATEMENT

This application claims priority under 35 U.S.C. Ø119 from Korean Patent Application No. 2008-129756, filed on Dec. 19, 2008 in the Korean Intellectual Property Office (KIPO), the contents of which are herein incorporated by reference in their entity.

### BACKGROUND OF THE INVENTION

1. Field of the Invention

The present disclosure is directed to a display substrate, a liquid crystal display (LCD) device having the display substrate and a method of manufacturing the display substrate. More particularly, the present disclosure is directed to a display substrate having improved display quality, an LCD device having the display substrate and a method of manufacturing the display substrate.

2. Description of the Related Art

Generally, a liquid crystal display (LCD) device displays an image by using optical anisotropy and polarization characteristics of liquid crystal molecules. That is, when a voltage is applied to the liquid crystal molecules having a thin and long molecular structure, the arrangement of the liquid crystal molecules is altered to control the amount of light passing through the liquid crystal. The LCD device freely modulates light polarized by the optical anisotropy of the liquid crystal to display desired image information.

A display panel of the LCD device is formed by injecting the liquid crystal between two substrates. To perform a function as the display device, the arrangement of the liquid crystal molecules should be uniformly controlled. Typically, an alignment layer capable of aligning the liquid crystal is formed to uniformly control the liquid crystal.

Recently, a technology for improving a viewing angle by controlling a pretilt angle formed on the alignment layer to embody a multi-domain structure has been developed. This technology has a photoalignment mode in which, when the alignment layer is irradiated by polarized ultraviolet (UV) light, a light effector is formed, which controls the alignment of the liquid crystal by a photopolymerization reaction.

However, in a boundary area of the multi-domain structure, a fringe field is generated by the alignment layer formed by the photoalignment mode. When the LCD device is operated, textures may be generated by the fringe field. Accordingly, display quality may be reduced.

### SUMMARY OF THE INVENTION

Exemplary embodiments of the present invention provide a display substrate having improved display quality by reducing generation of textures in a boundary area of a multi-domain structure.

Exemplary embodiments of the present invention also provide a liquid crystal display (LCD) device having the above-mentioned display substrate.

Exemplary embodiments of the present invention further provide a method of manufacturing the above-mentioned display substrate.

According to one exemplary embodiment of the present invention, a display substrate includes a lower base substrate, an organic insulation layer, an insulation protrusion, a pixel electrode and a lower alignment layer. The lower base substrate comprises a plurality of unit pixel areas defined thereon, each of the unit pixel areas divided into a plurality of sub-pixel areas arranged in a matrix pattern. The organic insulation layer is formed on the lower base substrate. The insulation protrusion is formed on the organic insulation layer to correspond to a boundary between the sub-pixel areas. The pixel electrode is formed on the organic insulation layer and the insulation protrusion. In addition, the lower alignment layer formed on the pixel electrode has different alignment directions formed by ultraviolet (UV) light irradiation that correspond to the sub-pixel areas.

In an exemplary embodiment of the present invention, the organic insulation layer may include a photoresist or a color filter.

In an exemplary embodiment of the present invention, the insulation protrusion includes an identical insulation material that is identical to the material of organic insulation layer, or an insulation material that is be identical to a material of a light-blocking member or a material of a column spacer.

In an exemplary embodiment of the present invention, the alignment directions of polymer chains of a surface of the lower alignment layer may be inclined within each of the sub-pixel areas when viewed from a plan view.

In an exemplary embodiment of the present invention, the display substrate may further include gate lines and data lines electrically connected to the pixel electrodes, and each of the alignment directions of adjacent sub-pixel areas form respectively, a positive 45° angle, a negative 45° angle, a positive 135° angle, and a negative 135° angle with respect to the gate line.

In an exemplary embodiment of the present invention, the alignment directions of the adjacent sub-pixel areas may converge to a center portion of the pixel electrode, when viewed from a plan view.

In an exemplary embodiment of the present invention, the alignment directions of the adjacent sub-pixel areas may include one pair that converges to a center portion of the pixel electrode and another pair that diverges from a center portion of the pixel electrode when viewed from a plan view.

In an exemplary embodiment of the present invention, the alignment directions of the sub-pixel areas may rotate in a right-hand direction or a left-hand direction.

According to another exemplary embodiment of the present invention, an LCD device includes a display substrate, an opposite substrate and a liquid crystal layer. The display substrate includes a lower base substrate having a plurality of unit pixel areas with each of the plurality of unit pixel areas divided into a plurality of sub-pixel areas arranged in a matrix pattern and an organic insulation layer having an insulation protrusion that corresponds to a boundary between the sub-pixel areas. The opposite substrate opposes the display substrate. In addition, the liquid crystal layer is interposed between the display substrate and the opposite substrate. At least one of the display substrate and the opposite substrate has an alignment direction that is determined by UV light irradiation.

In an exemplary embodiment of the present invention, the LCD device may further include a pixel electrode formed on the organic insulation layer where the pixel electrode is formed over the whole substrate corresponding to the sub-pixel areas.

In an exemplary embodiment of the present invention, the opposite substrate may include a common electrode and an upper alignment layer formed on the common electrode.

According to still another exemplary embodiment of the present invention, there is provided a method of manufacturing a display substrate. In the method, a lower base substrate is provided which includes a plurality of unit pixel areas, each of the unit pixel area is divided into a plurality of sub-pixel areas arranged in a matrix pattern, an organic insulation layer is formed which includes an insulation protrusion that corresponds to a boundary between the sub-pixel areas on the lower base substrate, a pixel electrode is formed on the organic insulation layer and the insulation protrusion, a light reactivity polymer film is formed on the pixel electrode and irradiated with polarized light to provide the sub-pixel areas with different alignment directions with respect to each other.

In an exemplary embodiment of the present invention, forming the organic insulation layer includes forming a photoresist layer on the lower base substrate and patterning the photoresist to form the insulation protrusion.

In an exemplary embodiment of the present invention, forming the organic insulation layer includes forming a photoresist layer on the lower base substrate and patterning the photoresist to form a color filter.

In an exemplary embodiment of the present invention, forming the organic insulation layer includes forming an organic insulation layer on the lower base substrate and forming on the organic insulation layer the insulation protrusion from a different organic material than the material of the organic insulation layer.

In an exemplary embodiment of the present invention, irradiating polarized light onto the light reactivity polymer film is performed by using a shadow mask having a blocking area to block one part of the sub-pixel areas and a transmission area to expose the other part of the sub-pixel areas, and by irradiating light through the transmission area onto the light reactivity polymer film.

In an exemplary embodiment of the present invention, the transmission area of the shadow mask transmits the light in a row direction parallel to gate lines electrically connected to the pixel electrode.

In an exemplary embodiment of the present invention, the transmission area of the shadow mask transmits the light in a column direction parallel to data lines electrically connected to the pixel electrode.

In an exemplary embodiment of the present invention, the transmission area of the shadow mask transmits the light in a direction inclined at about 45° to gate lines electrically connected to the pixel electrode.

In an exemplary embodiment of the present invention, the transmission area of the shadow mask is formed to correspond to the boundary between the sub-pixel areas, and the light is vertical to an incident surface of the transmission area.

According to an exemplary embodiment of the present invention, an insulation protrusion is formed below a pixel electrode that corresponds to a boundary between the sub-pixel areas of the display substrate, to substantially prevent generation of textures in the boundary. Accordingly, the display quality of the LCD device may be improved.

### BRIEF DESCRIPTION OF THE DRAWINGS

FIG. 1 is a perspective view illustrating a liquid crystal display (LCD) device according to an embodiment of the present invention.

FIG. 2 is a plan view illustrating an example of a construction on a unit pixel area of the LCD device of FIG. 1.

FIG. 3 is a cross-sectional view taken along a line I-I′ of FIG. 2.

FIG. 4 is a cross-sectional view taken along a line II-II′ of FIG. 2.

FIG. 5 is a flowchart illustrating a method of manufacturing a display substrate of FIGS. 3 and 4.

FIG. 6A is a plan view illustrating a first shadow mask used in an exposure process of the display substrate.

FIG. 6B is a plan view illustrating a second shadow mask used in an exposure process of the display substrate.

FIG. 7 is a perspective view illustrating a coordinate system defining an exposure direction and an alignment direction, with a lower alignment layer of the display substrate used as a reference plane.

FIGS. 8A to 8E are perspective views illustrating the alignment processes for forming the lower alignment layer.

FIG. 9 is a plan view illustrating the alignment directions of the lower alignment layer formed by the photoalignment processes.

FIG. 10A is a plan view illustrating a third shadow mask used in the exposure process of the display substrate according to an embodiment of the present invention;

FIG. 10B is a plan view illustrating a fourth shadow mask used in the exposure process of the display substrate according to an embodiment of the present invention:

FIGS. 11A to 11D are perspective views illustrating the photoalignment processes for forming the lower alignment layer of the display substrate.

FIG. 12 is a plan view illustrating the alignment direction of the lower alignment layer formed by the photoalignment processes.

FIGS. 13A and 13B are perspective views illustrating the photoalignment processes for forming an upper alignment layer of an opposite substrate according to another embodiment of the present invention.

FIG. 14 is a plan view illustrating a combination alignment direction embodied by the alignment direction of the lower alignment layer and the upper alignment layer.

### DETAILED DESCRIPTION OF EXEMPLARY EMBODIMENTS

Embodiments of the present invention are described more fully hereinafter with reference to the accompanying drawings, in which example embodiments of the present invention are shown. Embodiments of the present invention may, however, be embodied in many different forms and should not be construed as limited to the example embodiments set forth herein.

It will be understood that when an element or layer is referred to as being “on,” “connected to” or “coupled to” another element or layer, it can be directly on, connected or coupled to the other element or layer or intervening elements or layers may be present. Like numerals refer to like elements throughout.

Hereinafter, exemplary embodiments of the present invention will be explained in detail with reference to the accompanying drawings.

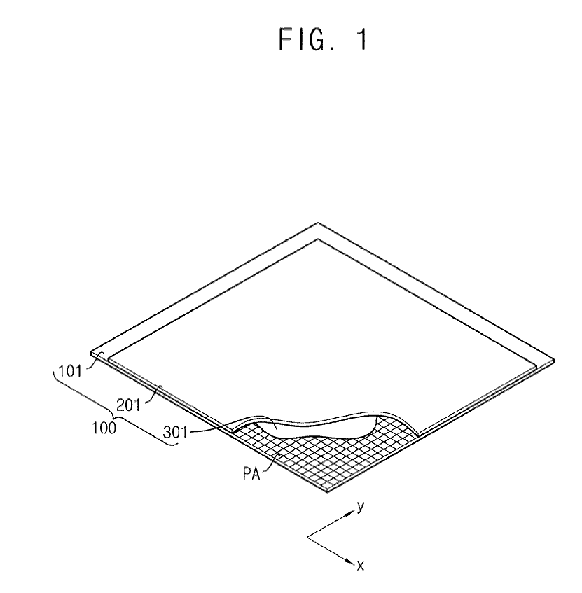

FIG. 1 is a perspective view illustrating a liquid crystal display (LCD) device according to an embodiment of the present invention.

Referring to FIG. 1, an LCD device 100 includes a display substrate 101, an opposite substrate 201 and a liquid crystal layer 301.

The display substrate 101 is bonded with the opposite substrate 201 opposite to the display substrate 101 by a frame-formed seal member. A display area PA is defined by the display substrate 101, the opposite substrate 201 and the seal member. Liquid crystal is sealed in the display area PA, completing the liquid crystal layer 301.

The display substrate 101 and the opposite substrate 201 are alignment substrates according to an embodiment of the invention. The display substrate 101 and the opposite substrate 201 align liquid crystal molecules of the liquid crystal layer 301.

The opposite substrate 201 may be a color substrate including RGB color filters. The display substrate 101 may be a component substrate driven in an active matrix driving method using a switching element.

The display substrate 101 may have a substantially rectangular shape. Accordingly, a width direction of the display substrate 101 is defined as a first direction X and a height direction of the display substrate 101 is defined as a second direction Y. A row direction of the present specification may refer to both the first direction X and a reverse direction of the first direction X. Accordingly, the first direction X corresponds to a positive row direction. A column direction may refer to both the second direction Y and a reverse direction of the second direction Y. Accordingly, the second direction Y corresponds to a positive column direction.

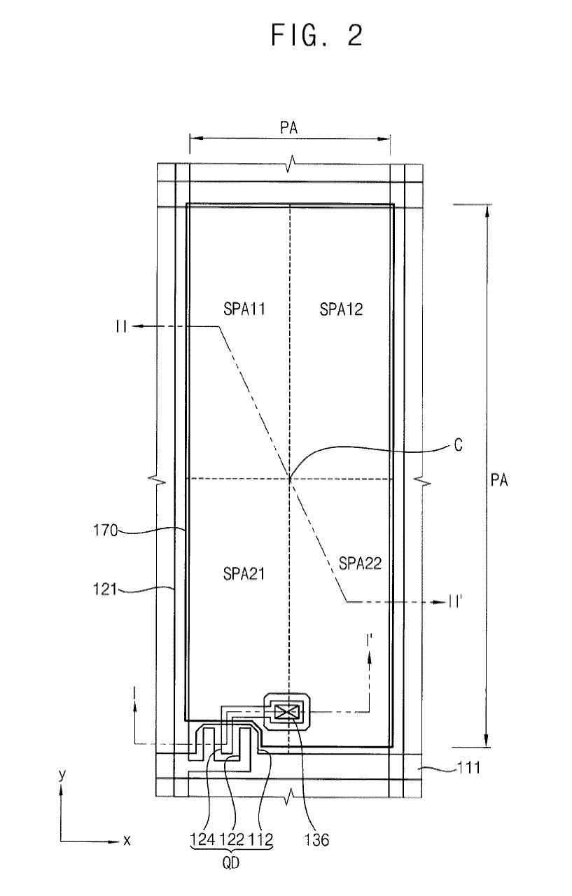

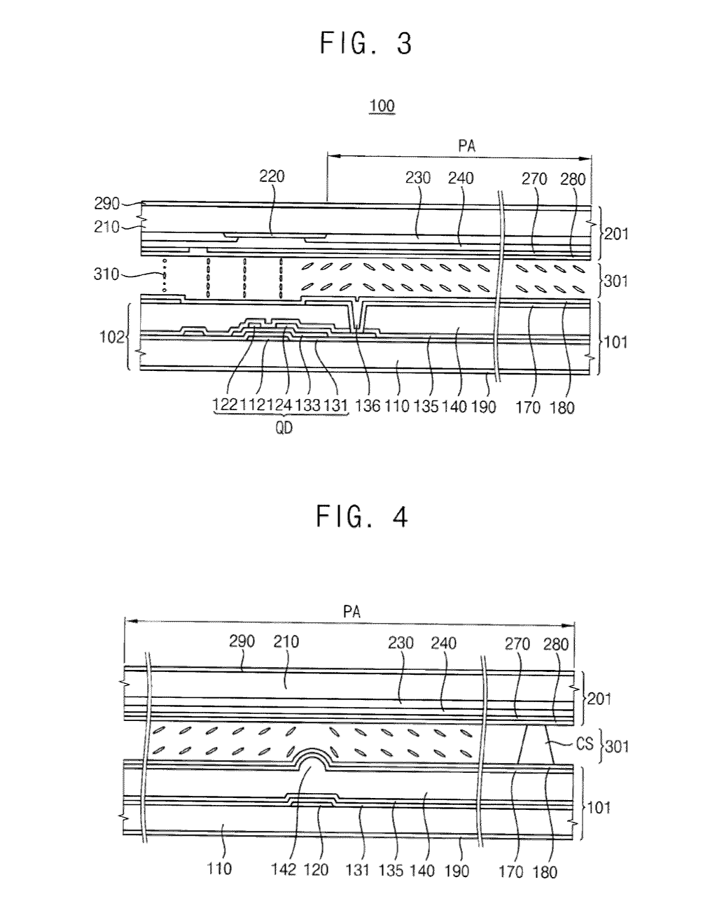

FIG. 2 is a plan view illustrating an example of a construction on a unit pixel area of the LCD device of FIG. 1. FIG. 3 is a cross-sectional view taken along a line I-I′ of FIG. 2.

Referring to FIGS. 1 to 3, the display substrate 101 comprises a lower substrate 102, pixel electrodes 170 and a lower alignment layer 180. The lower substrate 102 may comprise a lower base substrate 110, a plurality of gate lines 111, a plurality of data lines 121 and a switching element QD.

A plurality of unit pixel areas PA are defined on the lower base substrate 110 in a matrix pattern. The unit pixel area PA is defined as an individual area in which the liquid crystal layer 301 is independently controlled. The unit pixel areas PA may correspond to the RGB color filters of the opposite substrate 201, respectively.

In the embodiment of FIG. 1, the unit pixel area PA may be divided by a plurality of sub-pixel areas arranged in the matrix pattern. In FIG. 2, the unit pixel area PA is divided 4 sub-pixel areas SPA11, SPA12, SPA21 and SPA22 (for example, a first sub-pixel area SPA11 of a first row of a first column, a second sub-pixel area SPA12 of the first row of a second column, a third sub-pixel area SPA21 of a second row of the first column and a fourth sub-pixel area SPA22 of the second row of the second column). In the embodiment of FIG. 1, the unit pixel area PA is substantially rectangular shape. Alternatively, shapes of the pixel area PA may be variously changed to a V-shape, Z-shape, etc.

FIG. 4 is a cross-sectional view taken along a line II-II′ of FIG. 2.

Referring to FIGS. 2 to 4, a lower light-blocking pattern 120 is formed for preventing light leakage, which corresponds to a boundary between the sub-pixel areas SPA11, SPA12, SPA21 and SPA22 of the unit pixel area PA. In addition, an insulation protrusion 142 is formed for changing an electric field formed in the liquid crystal layer 301.

Referring to FIGS. 2 to 4 again, the boundary between the sub-pixel areas SPA11, SPA12, SPA21 and SPA22 has a cross shape. Accordingly, the insulation protrusion 142 may also have a cross shape. In this case, an intersection point C of the cross formed insulation protrusion 142 may be a half-moon shape or a diamond shape. In addition, the width and the height of an end portion of the cross-shape insulation protrusion 142 may be smaller than those of a center portion of the cross-shape insulation protrusion 142.

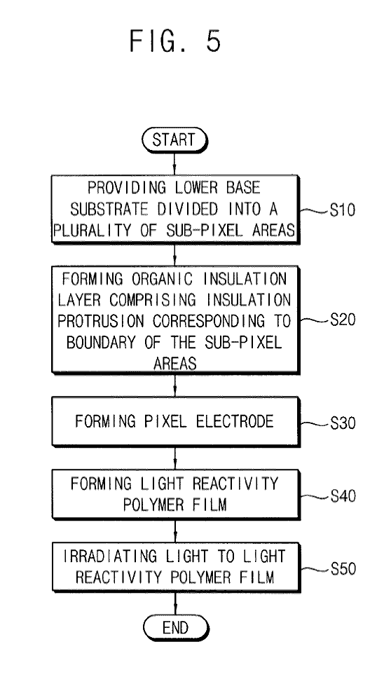

FIG. 5 is a flowchart illustrating a method of manufacturing a display substrate of FIGS. 3 and 4.

Referring to FIGS. 2 to 5, as described above, a plurality of unit pixel areas PA are defined. At step S10, the lower base substrate 110 comprising each of the unit pixel area PA which is divided into a plurality of sub-pixel areas SPA11, SPA12, SPA21 and SPA22 arranged in a matrix pattern is provided.

The gate line 111, the data line, 121 and the transistor QD are formed on the lower base substrate 110. The transistor QD may comprise a thin-film transistor (TFT). The pixel electrode 170 is formed on the lower substrate 102 comprising the base substrate 110, the gate line 111, the data line 121 and the transistor QD.

For example, a gate metal is vapor-deposited on the lower base substrate 110 of glass material using a sputtering method. The gate lines 111 and gate electrode 112 protruded from the gate lines 111 are formed from the gate metal by a photolithography process. The gate lines 111 are arranged on the lower base substrate 120 between the pixel areas PA extending substantially in the first direction x.

Storage lines (not shown) may be formed on the lower base substrate 110 of a piece with the gate line 111 from the same material as the gate line 111.

In addition, the lower light-blocking pattern 120 corresponding to the boundary among the sub-pixel areas SPA11, SPA12, SPA21 and SPA22 of the unit pixel area PA may be formed to prevent light leakage.

Then, the gate insulation layer 131 and the semiconductor pattern 133 are formed. The gate insulation layer 131 is formed over the gate line 111. A semiconductor layer is vapor-deposited and etched on the gate insulation layer 131 to form the semiconductor pattern 133. The semiconductor pattern 133 is formed over the gate insulation layer 131 on the gate electrode 112.

Then, a data metal is vapor-deposited and patterned on the gate insulation layer 131 to form the data line 121, the source electrode 122 and the drain electrode 124.

The data lines 121 extend substantially in the second direction y on the gate insulation layer 131. The source electrode 122 is protruded from the data line 121 adjacent to a crossing point of the gate line 111 and the data line 121, to be extended over the semiconductor pattern 133 on the gate electrode 112.

The drain electrode 124 is arranged to oppose to the source electrode 122 over the semiconductor pattern 133, extends over the gate insulation layer 131, and a part of the drain electrode 124 is disposed on the pixel area PA defined on the lower substrate 102.

The switching element QD includes the gate electrode 112, the gate insulation layer 131, the semiconductor pattern 133, the source electrode 122 and the drain electrode.

Then, a passivation film 135 is formed, which covers the lower base substrate 110 having the date line 121.

Then, at step S20, an organic insulation layer 140 including the insulation protrusion 142 corresponding to the boundary between the sub-pixel areas SPA11, SPA12, SPA21 and SPA22 is formed on the passivation film 135.

Contact holes 136 exposing a part of the drain electrode 124 are formed on the organic insulation layer 140 and the passivation film 135.

A color filter (not shown) may be used as the organic insulation layer 140. Such a display substrate structure refers to a color filter on array (COA) substrate. On the COA substrate, a TFT layer including the TFT may be formed on a base substrate, a color photoresist layer may be formed on the TFT layer, and the color filter may be formed in a pixel area by patterning the color photoresist layer. A pixel electrode electrically connected to the TFT is formed in the pixel area including the formed color filter, to complete the COA substrate. On the opposite substrate opposed to the COA substrate, a common electrode opposed to the pixel electrode and a light-blocking member may be formed.

The insulation protrusion 142 is formed corresponding to the boundary between the sub-pixel areas SPA11, SPA12, SPA21 and SPA22 on the organic insulation layer 140.

The insulation protrusion 142 has a shape by which the organic insulation layer 140 is protruded. In this case, the organic insulation layer 140 may be formed as the photoresist layer. For example, the photoresist layer is formed on the TFT layer, and the photoresist layer is patterned, so that the insulation protrusion 142 may be formed.

Likewise, the insulation protrusion 142 may be formed on the color filter. In this case, the insulation protrusion 142 is formed when the color photoresist layer is patterned.

The insulation protrusion 142 may be formed of an organic material, such as the same material as a column spacer CS, the organic insulation layer 140, or the color filter, and may be formed when the column spacer CS spacing the display substrate 101 and the opposite substrate 201 is formed. In addition, when the light-blocking member (not shown) is formed on the display substrate 101, the insulation protrusion 142 is formed of the organic material, that is, the same material with the light-blocking member.

The insulation protrusion 142 may be formed before forming the pixel electrode 170, or with the organic insulation layer 140 or the color filter. For example, when a black matrix (not shown) for preventing light leakage between one unit pixel area PA and another pixel area PA is formed, the insulation protrusion 142 may be formed of the same material with the black matrix.

The insulation protrusion 142 is formed below the pixel electrode 170. Accordingly, the pixel electrode 170 may be protruded toward the opposite substrate 201 by the insulation protrusion 142.

Accordingly, the electrical field of the liquid crystal layer 301 may be changed by the insulation protrusion 142. As a result, the insulation protrusion 142 may improve the reactivity of the liquid crystal layer 301. Accordingly, textures that may be generated at the boundary may be reduced.

Then, at step S30, a transparent conductivity material layer such as ITO or IZO is vapor-deposited and pattered on the organic insulation layer 140 to form the pixel electrode 170. So, the lower substrate 102 including the pixel electrode 170 is provided. The pixel electrode 170 contacts the drain electrode 124 through the contact hole 136.

The pixel electrode 170 may be formed on the whole substrate corresponding to the sub-pixel area SPA11, SPA12, SPA21 and SPA22 arranged in a matrix pattern.

Then, at step S40, the light reactivity polymer film (not shown) is formed on the lower substrate 102 (STEP S40).

The light reactivity polymer film is formed by spreading and hardening a cinnamate-type light reactivity polymer and a blend of polyimide-type polymers on the pixel electrode 170.

For example, the cinnamate-type light reactivity polymer and the blend of polyimide-type polymers are blended in a portion of 1:9 (weight/weight) to 9:1 (weight/weight) to dissolve in an organic solvent. The dissolved polymer in the organic solvent may be spin-coated spread on the substrate. Then, the light reactivity polymer film is formed by heating and hardening the coated polymer on the substrate.

Then, at step S50, UV light is irradiated onto the light reactivity polymer film, and the light reactivity polymer film of each of the sub-pixel areas is photoaligned to have a plurality of alignment directions different from each other, to form the lower alignment layer 180.

The UV light may be irradiated over the whole of the light reactivity polymer film. In addition, the UV light may be a slit beam. The slit beam may be irradiated corresponding to the light reactivity polymer of each of the sub-pixel areas. The lower alignment layer 180 serves as a vertical alignment layer. In this case, the electrical field of the liquid crystal layer 301 may be changed by the insulation protrusion 142. Accordingly, textures that may be generated at the boundary may be reduced.

For example, photoaligned polymer chains on the surface of the lower alignment layer 180 have alignment directions formed in an oblique direction in the sub-pixel areas SPA11, SPA12, SPA21 and SPA22.

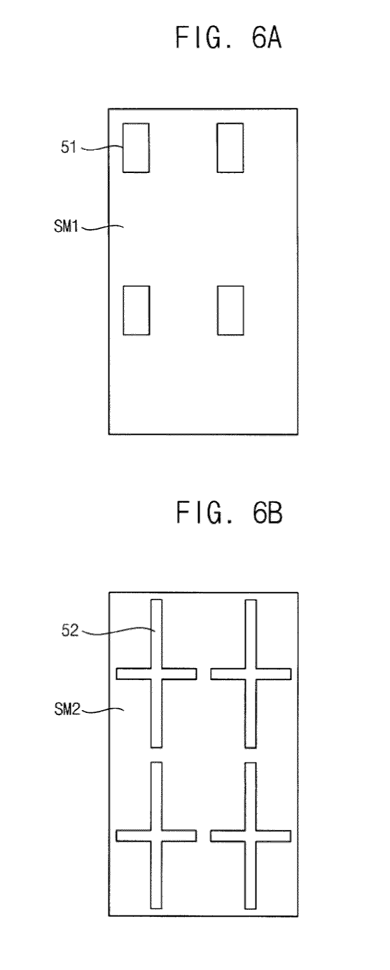

FIG. 6A is a plan view illustrating a first shadow mask used in an exposure process of the display substrate. FIG. 6B is a plan view illustrating a second shadow mask used in an exposure process of the display substrate.

Referring to FIGS. 6A and 6B, UV light may be filtered by the first shadow mask SM1 and the second shadow mask SM2 disposed over the light reactivity polymer film to irradiate on the light reactivity polymer film.

First transmission areas 51 are formed on the first shadow mask SM1, which correspond to a portion of the unit pixel area PA. The first transmission area 51 of the first shadow mask SM1 may be disposed to correspond to parts of the sub-pixel areas SPA11, SPA12, SPA21 and SPA22. Accordingly, UV light may be irradiated onto the light reactivity polymer film of the sub-pixel areas SPA11, SPA12, SPA21 and SPA22 through the first transmission area 51 of the first shadow mask SM1.

Second transmission areas 52 are formed on the second shadow mask SM2, which correspond to boundaries between the 4 sub-pixel areas SPA11, SPA12, SPA21 and SPA22 of the unit pixel area PA. Accordingly, UV light may be irradiated onto the boundaries of the sub-pixel areas SPA11, SPA12, SPA21 and SPA22 through the second transmission areas 52 of the second shadow mask SM2.

The UV light may be vertically inclined.

For example, liquid crystal molecules of the boundaries may be slightly inclined into an incident direction of the vertical UV light to have a pretilt angle. Accordingly, reactivity of the liquid crystal may be improved.

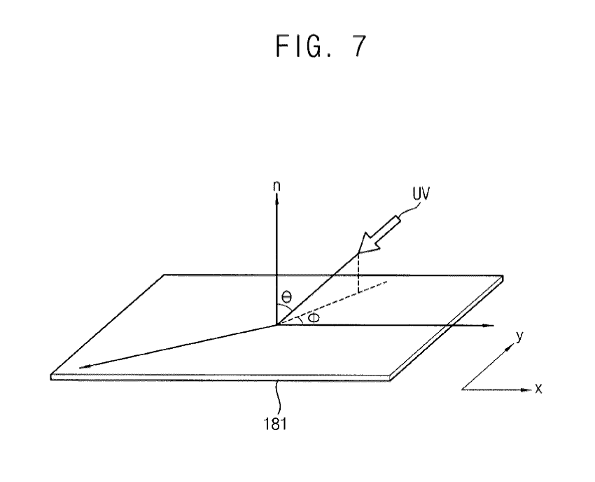

FIG. 7 is a perspective view illustrating a coordinate system defining an exposure direction and an alignment direction, with a lower alignment layer of the display substrate used as a reference plane.

Referring to FIG. 7, the action of UV light is a function of a degree to which the light reactivity polymer film 181 is aligned. The energy units of UV light are watt×sec [Wsec], that is, [Joules].

In FIG. 7, an incident angle θ is defined by the angle formed by the vector normal to the light reactivity polymer film 181 and the UV light. Accordingly, the angle formed by the normal vector of the light reactivity polymer film 181 and the UV light is represented by θ, and the θ is defined as an exposure angle. An angle between the first direction (x), that is, a positive row direction, and a projection of the the UV light onto the plane of the light reactivity polymer film 181 is defined as an azimuth Ø.

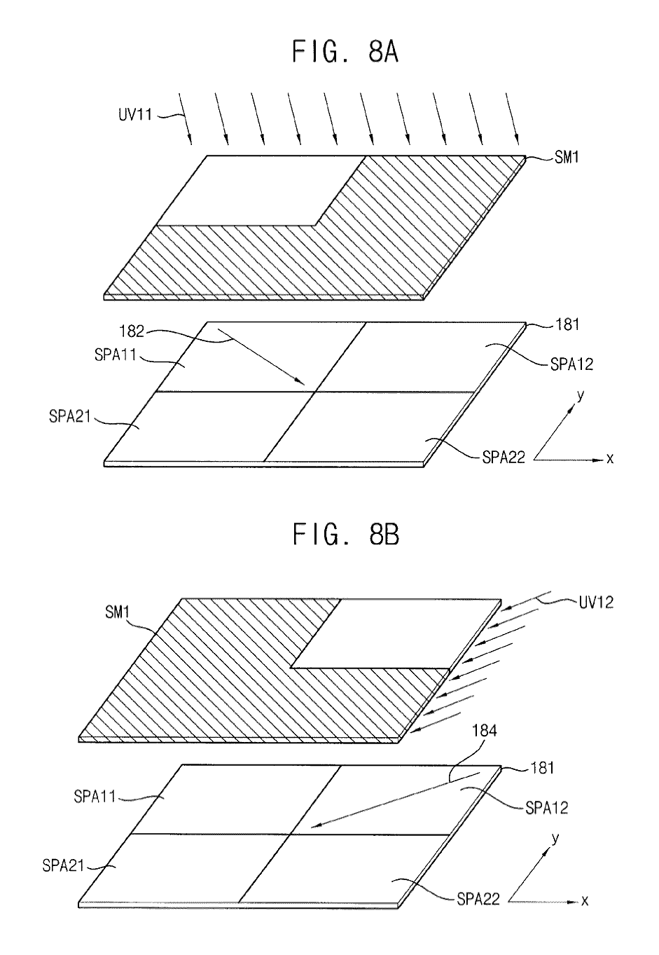

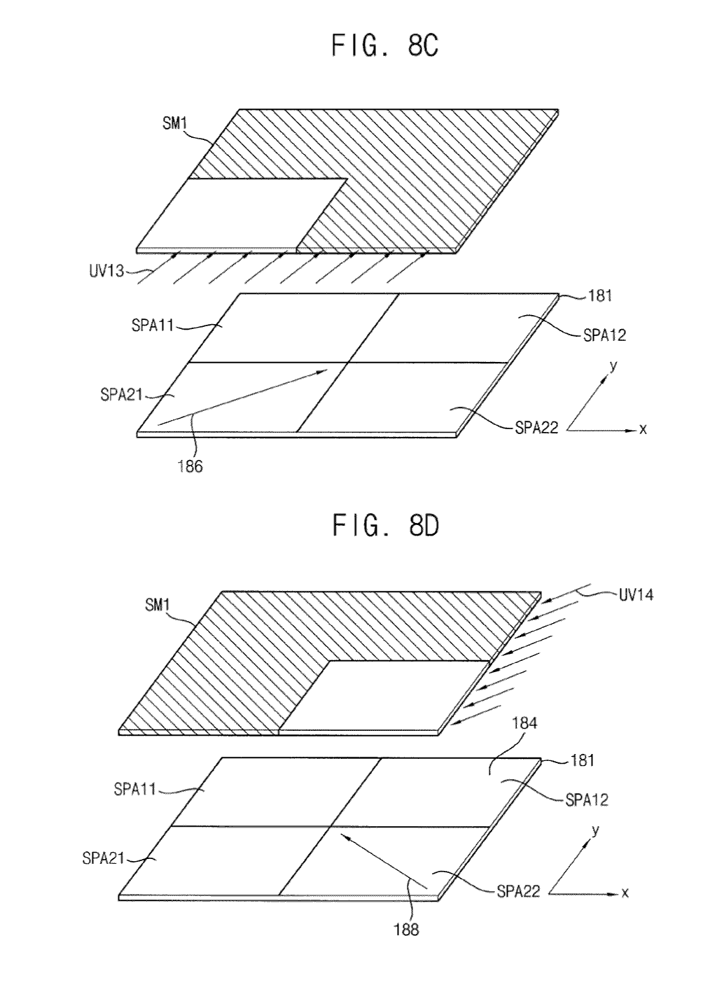

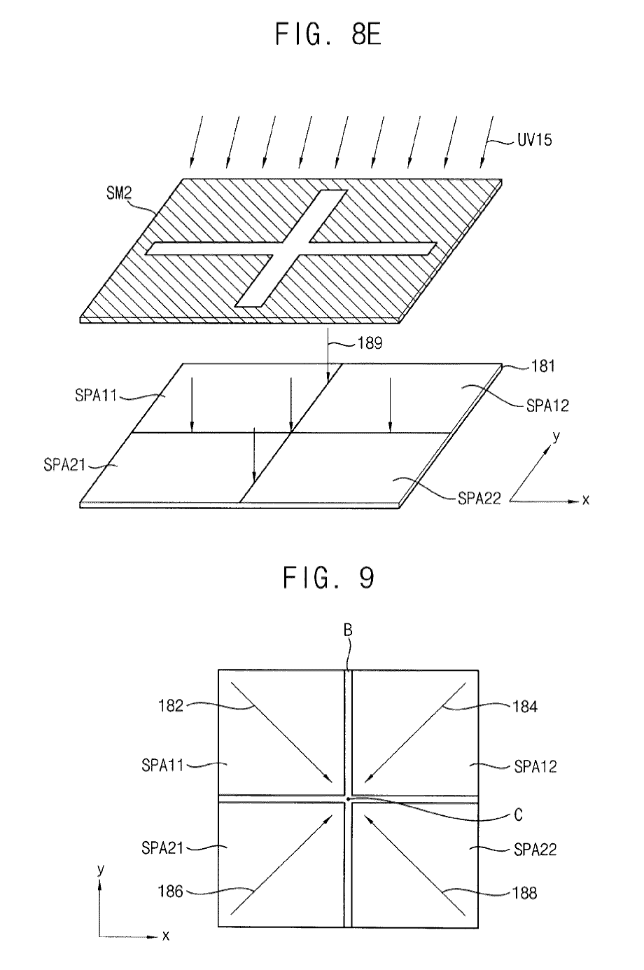

FIGS. 8A to 8E are perspective views illustrating the alignment processes for forming the lower alignment layer.

According to the embodiment of FIG. 1, a plurality of alignment directions are formed on the light reactivity polymer film 181 of each of the sub-pixel areas SPA11, SPA12, SPA21 and SPA22.

First, referring to FIG. 8A, the unit pixel area PA is first-exposed using the first transmission areas 51 of the first shadow mask SM1.

For example, the first transmission areas 51 of the first shadow mask SM1 are disposed to correspond to the first sub-pixel area SPA11, and the other sub-pixel areas SPA12, SPA21, and SPA22 are blocked by the other part of the first shadow mask SM1.

Here, the first UV light 11 is irradiated onto the light reactivity polymer film 181, so that a first alignment direction 182 is formed on the light reactivity polymer film 181 in a direction that is a vector sum of the positive row direction and the negative column direction.

Referring to FIG. 8B, the unit pixel area PA is second-exposed using the first transmission area 51 of the first shadow mask SM1.

For example, the first transmission area 51 of the first shadow mask SM1 is disposed to correspond to the second sub-pixel area SPA12, and the other sub-pixel areas SPA11, SPA21 and SPA22 are blocked by the other part of the first shadow mask SM1.

Here, the second UV light 12 is irradiated onto the light reactivity polymer film 181, so that a second alignment direction 184 is formed on the light reactivity polymer film 181 in a direction that is a vector sum of the negative row direction and the negative column direction.

Referring to FIG. 8C, the unit pixel area PA is third-exposed using the first transmission area 51 of the first shadow mask SM1.

For example, the first transmission area 51 of the first shadow mask SM1 is disposed to correspond to the third sub-pixel area SPA21, and the other sub-pixel areas SPA11, SPA12 and SPA22 are blocked by the other part of the first shadow mask SM1.

Here, the third UV light 13 is irradiated onto the light reactivity polymer film 181, so that a third alignment direction 186 is formed on the light reactivity polymer film 181 in a direction that is a vector sum of the negative row direction and the positive column direction.

Referring to FIG. 8D, the unit pixel area PA is fourth-exposed using the first transmission area 51 of the first shadow mask SM1.

For example, the first transmission area 51 of the first shadow mask SM1 is disposed to correspond to the fourth sub-pixel area SPA22, and the other sub-pixel areas SPA11, SPA12 and SPA21 are blocked by the other part of the first shadow mask SM1.

Here, the fourth UV light 14 is irradiated onto the light reactivity polymer film 181, so that a fourth alignment direction 188 is formed on the light reactivity polymer film 181 in a direction that is a vector sum of the negative row direction and the positive column direction.

Referring to FIG. 8E, the boundary between the sub-pixel areas SPA11, SPA12, SPA21 and SPA22 in the unit pixel area PA is fifth-exposed using the second transmission area 52 of the second shadow mask SM2.

For example, the second transmission area 52 of the second shadow mask SM2 is disposed to correspond to the boundary between the 4 adjacent sub-pixel areas SPA11, SPA12, SPA21 and SPA22, and the 4 adjacent sub-pixel areas SPA11, SPA12, SPA21 and SPA22 are blocked by the other part of the second shadow mask SM2.

Here, the fifth UV light 15 is vertically irradiated onto the incident surface of the light reactivity polymer film 181, so that a vertical alignment 189 is formed on the light reactivity polymer film 181.

Accordingly, the liquid crystal molecules of the liquid crystal layer 301 are slightly inclined toward the incident direction of the fifth UV light (UV15) to have a pretilt angle. So, the reactivity of the liquid crystal may be improved.

Here, not using the second shadow mask SM2, the fifth UV light (UV15) may be vertically irradiated onto the whole light reactivity polymer film 181.

In this case, although the fifth UV light (UV15) is irradiated onto the sub-pixel areas SPA11, SPA12, SPA21 and SPA22 after the first exposure process to the fourth exposure process have been performed, there is essentially no change of the alignment directions of the light reactivity polymer film 181 corresponding to the sub-pixel areas SPA11, SPA12, SPA21 and SPA22.

Accordingly, since the number of the masks is reduced, manufacturing costs may be reduced.

FIG. 9 is a plan view illustrating the alignment directions of the lower alignment layer formed by the photoalignment processes.

Referring to FIGS. 8A to 8E and 9, the first alignment direction 182 to the fourth alignment direction 188 are formed on the light reactivity polymer film 181 of each of the sub-pixel areas SPA11, SPA12, SPA21 and SPA22 by the first exposure process to the fourth exposure process, to form the lower alignment layer 180.

Although not shown in FIG. 9, the vertical alignment direction 189 is formed on the boundary B among the sub-pixel areas SPA11, SPA12, SPA21 and SPA22.

Likewise, a non-exposure area may be formed on the boundary B. In this case, irradiation of UV light having different directions is prevented on the boundary B, to remove the possibility of generating a mismatched surface on the boundary B. In addition, the reactivity of the liquid crystal of the boundary B is improved by the insulation protrusion 142 to reduce the generation of the textures on the boundary B.

When the liquid crystal molecules of the liquid crystal later 301 are disposed on the lower alignment layer 180, the liquid crystal molecules are pretilted in the first alignment direction 182 to the fourth alignment direction 188.

According to the embodiment of FIG. 1, the lower alignment directions may comprise the first alignment direction 182 to the fourth alignment direction 188 by the first exposure process to the fourth exposure process described with reference to FIGS. 8A to 8D.

For example, the lower alignment directions, that is, each of the alignment directions of the 4 adjacent sub-pixel areas SPA11, SPA12, SPA21 and SPA22 may have a positive 45°, a negative 45°, a positive 135°, and a negative 135° direction for the gate line. The alignment directions of the 4 adjacent sub-pixel areas SPA11, SPA12, SPA21 and SPA22 may converge toward the center portion of the pixel electrode 170.

The alignment directions between 2 sub-pixel areas having the same boundary are disposed to cross at a right angle, and the alignment directions between 2 sub-pixel areas not having the same boundary are disposed on a same extended line. Each of the first alignment direction 182 to the fourth alignment direction 188 may be disposed at an angle with respect to the first direction x, namely, the positive 45°, the negative 45°, the positive 135° and the negative 135°.

Referring to FIGS. 3 and 4, the opposite substrate 201 may comprise an upper base substrate 210, an upper light-blocking pattern 220, a color filter pattern 230, an overcoat layer 240, a common electrode 270 and an upper alignment layer 280.

The upper light-blocking pattern 220 is formed on a lower surface of the base substrate 210 corresponding to the gate line 111, the data line 121 and the switching element QD.

The color filter pattern 230 is formed on the upper base substrate 210 corresponding to the pixel area PA. For example, the color filter pattern 230 may comprise a red filter, a green filter and a blue filter. The color filter pattern 230 may be arranged on the pixel area PA, in the first direction x in order of the red filter, the green filter and the blue filter.

When the color filter is formed on the display substrate 101, the color filter pattern 230 may be omitted.

The overcoat layer 240 covers the color filter pattern 230 and the upper light-blocking pattern 220, and the common electrode 270 is formed on the overcoat layer 240.

The upper alignment layer 280 is formed on the common electrode 270. The upper alignment layer 280 may be photoalignment processed so that parts of the upper alignment layer 280 corresponding to each of the sub-pixel areas have different alignment directions. The upper alignment directions of the upper alignment layer 280 corresponding to each of the sub-pixel areas may be formed to converge toward the center (crossing point) C of the sub-pixel areas SPA11, SPA12, SPA21 and SPA22, the same as with the lower alignment directions. Alternatively, the upper alignment directions may be formed to rotate to the right-hand direction or the left-hand direction, and to vertically align. In addition, an exposure process of the upper alignment layer 280 may be omitted.

The LCD 100 is manufactured by combining the display substrate 101 and the opposite substrate 201 and injecting the liquid crystal between the display substrate 101 and the opposite substrate 201 to form the liquid crystal layer 301.

The lower alignments direction of the display substrate 101 and the upper alignment directions of the opposite substrate 201 may be vector summed to determine a combination alignment direction.

For example, when an electric field is not applied to the liquid crystal molecules of the liquid crystal layer 301, the liquid crystal molecules of the liquid crystal layer 301 may be in a vertical alignment mode vertically aligned to the display substrate 101 and the opposite substrate 201. The liquid crystal molecules are inclined with the pretilt angle in the lower alignment direction in the lower alignment layer 180, and are inclined with the pretilt angle in the upper alignment direction in the upper alignment layer 280.

Referring to FIG. 3 again, a lower polarizing substrate 190 may be attached on a rear surface of the display substrate 101. An upper polarizing substrate 290 may be attached on a front surface of the opposite substrate 201. Polarizing axes of the lower polarizing substrate 190 and the upper polarizing substrate 290 may be disposed to be perpendicular to each other. For the most efficient light filtering, the liquid crystal molecules are aligned with a tilt of about 45° for the polarizing axes.

Accordingly, in the above described photoalignment method, the upper alignment directions and the lower alignment directions may be formed to have tilts of about 45° or about 135° for the polarizing axes of the lower polarizing substrate 190 and the upper polarizing substrate 290.

According to the embodiment of FIG. 1 of the present invention, when a slit beam is irradiated onto the sub-pixel areas SPA11, SPA12, SPA21 and SPA22, the slit beam may be locally irradiated one by one. Accordingly, costs according to the power consumption of a light source may be reduced.

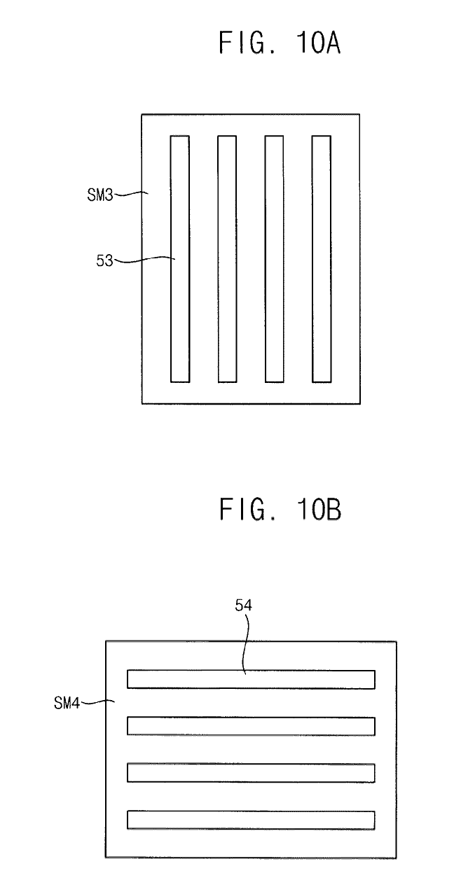

FIG. 10A is a plan view illustrating a third shadow mask used in the exposure process of the display substrate according to an embodiment of the present invention. FIG. 10B is a plan view illustrating a fourth shadow mask used in the exposure process of the display substrate according to an embodiment of the present invention.

An LCD device according to an embodiment of FIGS. 10A-10B is substantially the same as the LCD device according to an embodiment of FIG. 5, except for at least the lower alignment direction and the upper alignment direction. In addition, a method of manufacturing a display substrate of the LCD device of an embodiment of FIGS. 10A-10B is substantially the same as the method of manufacturing the display substrate of FIG. 5, except for at least the exposure processes of the display substrate. Accordingly, corresponding reference numbers will be used for the corresponding elements, and repeated explanations will be omitted.

Referring to FIGS. 10A and 10B, UV light is filtered by a third shadow mask SM3 and a fourth shadow mask SM4 disposed above the light reactivity polymer film 181, and the second shadow mask SM2 is used to irradiate to the light reactivity polymer film 181.

Third transmission areas 53 are formed to correspond to the first sub-pixel area SPA11 and the third sub-pixel area SPA21 or the second sub-pixel area SPA12 and the fourth sub-pixel area SPA22 of the unit pixel area PA. Accordingly, the UV light may be irradiated onto the light reactivity polymer film 181 of the first sub-pixel area SPA11 and the third sub-pixel areas SPA21 through the third transmission area 53 of the third shadow mask SM3. In addition, the UV light may be irradiated onto the light reactivity polymer film 181 of the second sub-pixel area SPA12 and the fourth sub-pixel area SPA22 through the third transmission area 53 of the third shadow mask SM3.

The third shadow mask SM3 may pass light in a column direction.

Fourth transmission areas 54 are formed to correspond to the first sub-pixel area SPA11 and the second sub-pixel area SPA12 or the third sub-pixel area SPA21 and the fourth sub-pixel area SPA22 of the unit pixel area PA. Accordingly, the UV light may be irradiated onto the light reactivity polymer film 181 of the first sub-pixel area SPA11 and the second sub-pixel areas SPA12 through the fourth transmission area 54 of the fourth shadow mask SM4. In addition, the UV light may be irradiated onto the light reactivity polymer film 181 of the third sub-pixel area SPA21 and the fourth sub-pixel area SPA22 through the fourth transmission area 54 of the fourth shadow mask SM4.

The fourth shadow mask SM4 may pass light in a row direction.

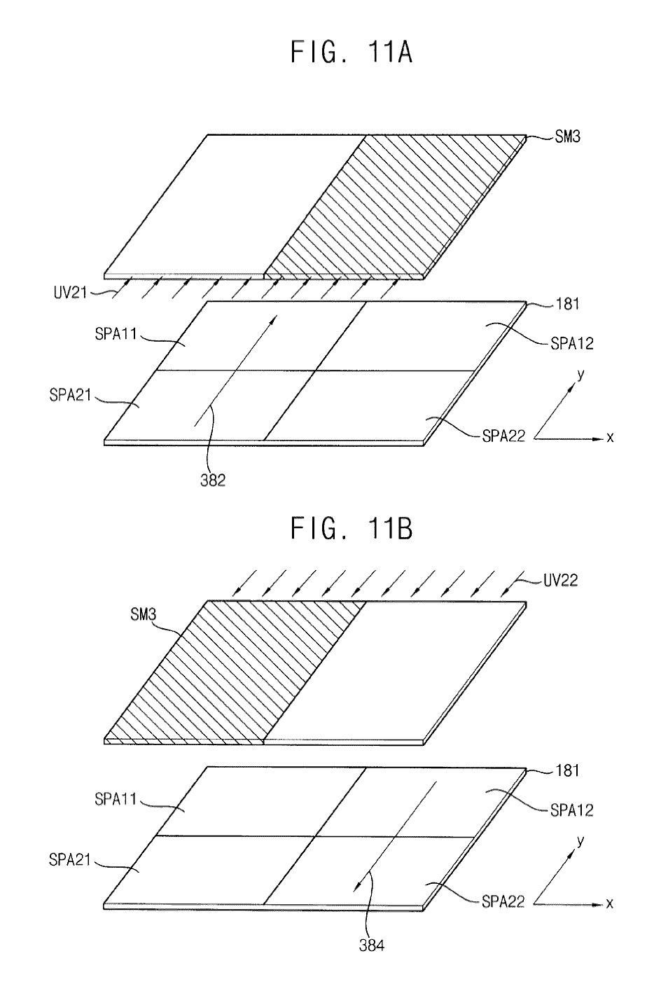

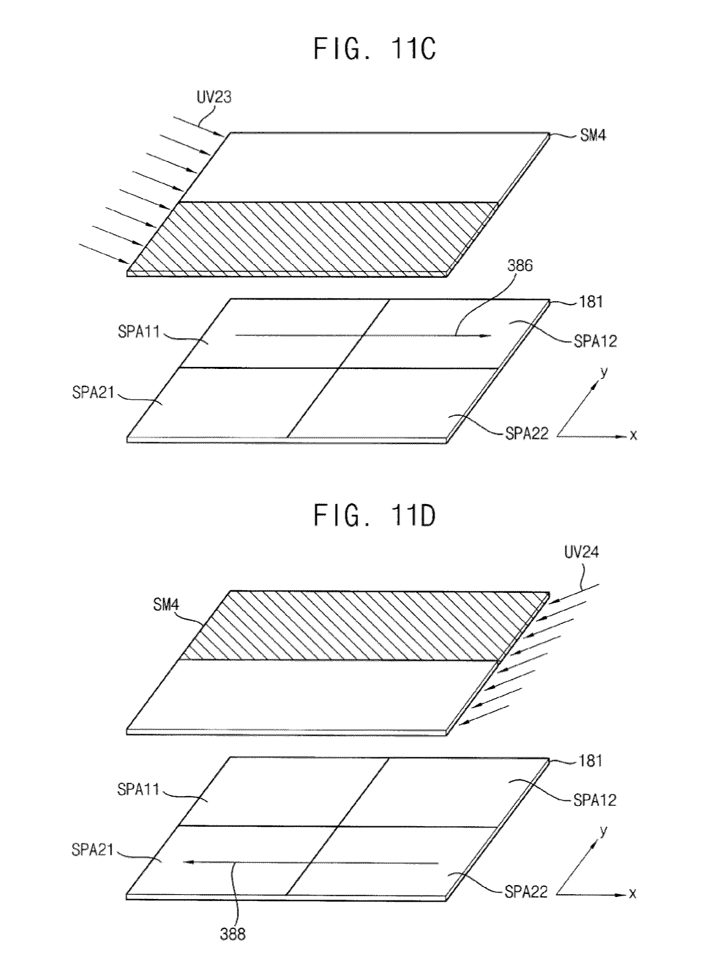

FIGS. 11A to 11D are perspective views illustrating the photoalignment processes forming the lower alignment layer of the display substrate.

In the embodiment of FIGS. 10A-10B, a plurality of alignment directions are formed on the light reactivity polymer film 181 of each of the sub-pixel areas. For example, in each of the sub-pixel areas, the light reactivity polymer film 181 is photoalignment processed in the row direction and in the column direction, 2 times by 2 times.

First, referring to FIG. 11A, the unit pixel area PA is first exposed using the third transmission area 53 of the third shadow mask SM3.

For example, the third transmission area 53 of the third shadow mask SM3 is disposed to correspond to the first sub-pixel area SPA11 and the third sub-pixel area SPA21. The other sub-pixel areas, that is, the second sub-pixel area SPA12 and the fourth sub-pixel area SPA22 are blocked by the other parts of the third shadow mask SM3.

Here, the first UV light (UV21) is irradiated onto the light reactivity polymer film 181, so that the light reactivity polymer film 181 has a first pretilt angle direction 382 in the positive column direction.

Referring to FIG. 11B, the unit pixel area PA is second exposed using the third transmission area 53 of the third shadow mask SM3.

For example, the third transmission area 53 of the third shadow mask SM3 is disposed to correspond to the second sub-pixel area SPA12 and the fourth sub-pixel area. The other sub-pixel areas, that is, the first sub-pixel area SPA11 and the third sub-pixel area SPA21 are blocked by the other parts of the third shadow mask SM.

Here, the second UV light (UV22) is irradiated onto the light reactivity polymer film 181, so that the light reactivity polymer film 181 has a second pretilt angle direction 384 in the negative column direction.

Referring to FIG. 11C, the unit pixel area PA is third exposed using the fourth transmission area 54 of the fourth shadow mask SM4.

For example, the fourth transmission area 54 of the fourth shadow mask SM4 is disposed to correspond to the first sub-pixel area SPA11 and the second sub-pixel area SPA12. The other sub-pixel areas, that is, the third sub-pixel area SPA21 and the fourth sub-pixel area SPA22 are blocked by the other parts of the fourth shadow mask SM4.

Here, the third UV light (UV23) is irradiated onto the light reactivity polymer film 181, so that the light reactivity polymer film 181 has a third pretilt angle direction 386 that is a vector sum of the negative row direction and the positive row direction.

Referring to FIG. 11D, the unit pixel area PA is fourth exposed using the fourth transmission area 54 of the fourth shadow mask SM4.

For example, the fourth transmission area 54 of the fourth shadow mask SM4 is disposed to correspond to the third sub-pixel area SPA21 and the fourth sub-pixel area SPA22. The other sub-pixel areas, that is, the first sub-pixel area SPA11 and the second sub-pixel area SPA12 are blocked by the other parts of the fourth shadow mask SM4.

Here, the fourth UV light (UV24) is irradiated onto the light reactivity polymer film 181, so that the light reactivity polymer film 181 has a fourth pretilt angle direction 388 that is a vector sum of the negative row direction and the positive row direction.

Since the fifth exposure of the boundary between the sub-pixel areas SPA11, SPA12, SPA21 and SPA22 of the unit pixel area PA using the second transmission area 52 of the second shadow mask SM2 is substantially the same as shown in FIG. 8E, a repeated explanation will be omitted.

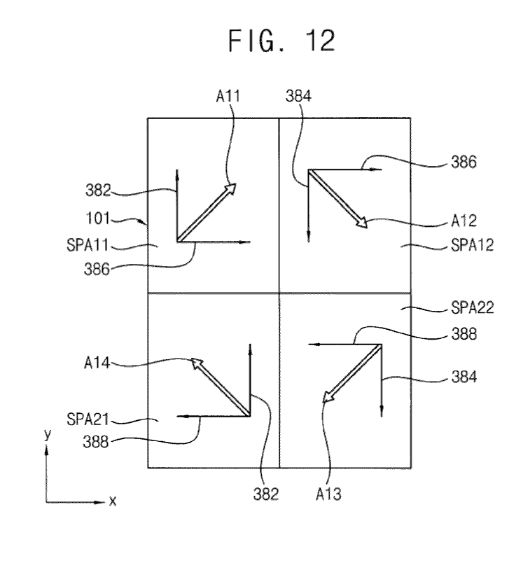

FIG. 12 is a plan view illustrating the alignment directions of the lower alignment layer formed by the photoalignment processes.

Referring to FIG. 12, as shown in FIG. 12, 2 pretilt angle directions, a row direction and a column direction, are formed on the light reactivity polymer film 181 of each of the sub-pixel areas SPA11, SPA12, SPA21 and SPA22 by the first exposure process to the fourth exposure process, to complete the lower alignment layer 180.

In addition, the vertical alignment direction is formed by the fifth exposure process on the boundary B between the sub-pixel areas SPA11, SPA12, SPA21 and SPA22 of the light reactivity polymer film 181.

When the liquid crystal molecules of the liquid crystal 301 are disposed on the lower alignment layer 180, the liquid crystal molecules align in a first lower alignment direction A11, a second lower alignment direction A12, a third lower alignment direction A13 and a fourth lower alignment direction A14 that are vector sums of the column direction pretilt angle direction (the first pretilt angle direction 382 and the second pretilt angle direction 384) and the row direction pretilt angle direction (the third pretilt angle direction 386 and the fourth pretilt angle direction 388). Here, the alignment directions of each of the sub-pixel areas SPA11, SPA12, SPA21 and SPA22 are defined as the first lower alignment direction A11, the second lower alignment direction A12, the third lower alignment direction A13 and the fourth lower alignment direction A14.

That is, the liquid crystal molecules are pretilted according to the lower alignment directions A11, A12, A13 and A14.

In the embodiment of FIGS. 10A-10B, the first lower alignment direction A11 to the fourth lower alignment direction A14 are arranged to rotate in a right-hand direction, by the exposure processes described in FIGS. 11A to 11D.

Alternatively, the first lower alignment direction A11 to the fourth lower alignment direction A14 may be arranged to rotate in a left-had direction by varying the order of the first to the fourth exposure processes.

In addition, the first lower alignment direction A11 to the fourth lower alignment direction A14 may be formed as one pair converging into the center portion of the pixel electrode 170 and another pair diverging from the center portion of the pixel electrode 170, when the display substrate 101 is observed on a plane surface.

Since the upper alignment layer according to the embodiment of FIGS. 10A-10B is substantially the same as the upper alignment layer 280 according to the embodiment of FIGS. 3 and 4, repetitive explanations will be omitted.

The display substrate 101 is combined with the opposite substrate 201 and the liquid crystal is injected between the display substrate 101 and the opposite substrate 201 to form the liquid crystal layer 301, to manufacture an LCD device 100.

Here, the alignment direction of the display substrate 101 and the alignment direction of the opposite substrate 201 may be vector-summed to determine the combination alignment direction of the LCD device.

According to the embodiment of FIGS. 10A-10B of the present invention, UV light may be irradiated onto the light reactivity polymer film 181 in a row direction and a column direction. Irradiating UV light in the row direction and the column direction is more effective than irradiating UV light in different directions, and simplifies the exposure process.

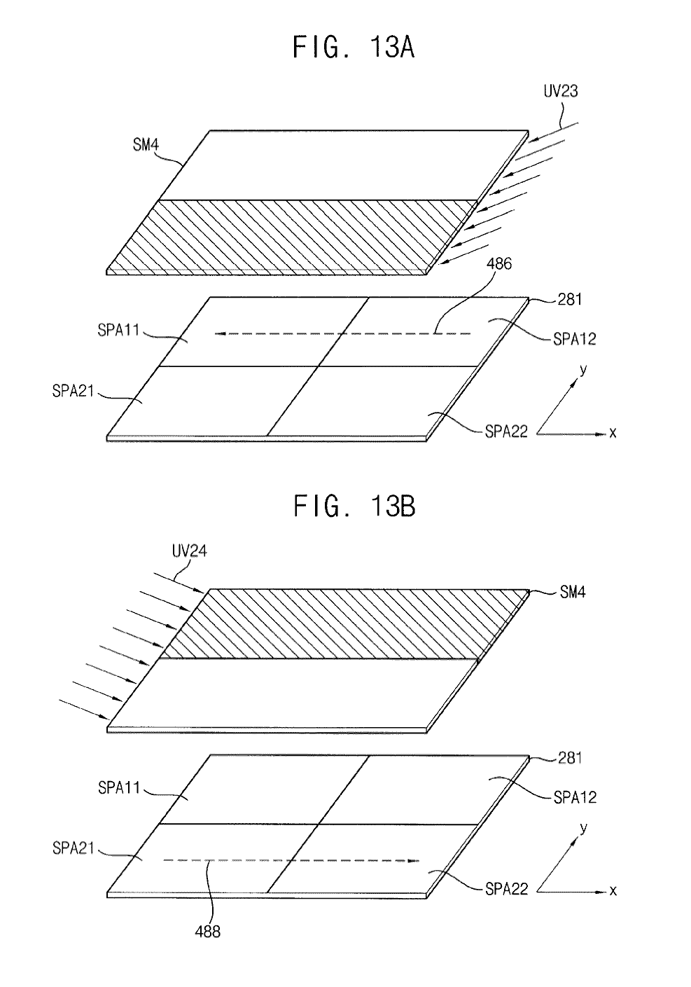

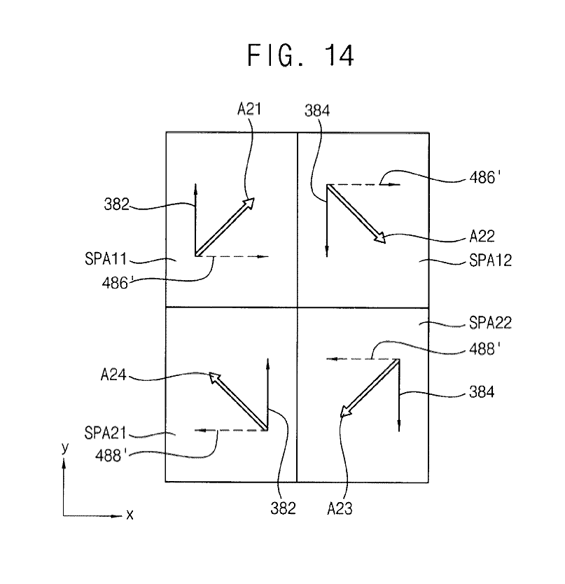

FIGS. 13A and 13B are perspective views illustrating the photoalignment processes forming an upper alignment layer of an opposite substrate according to another embodiment of the present invention.

An LCD device according to the embodiment of FIGS. 13A-13B is substantially the same as the LCD device 100 according to the embodiment of FIG. 1 except for at least a lower alignment direction and an upper alignment direction. In addition, except for at least the exposure process of the display substrate, a method of manufacturing the display substrate of Embodiment 3 is substantially the same as the method of manufacturing the display substrate of FIG. 5. Accordingly, corresponding reference numbers will be used for the corresponding elements, and repeated explanations will be omitted.

Here, the second shadow mask SM2, the third shadow mask SM3 and the fourth shadow mask SM4 are substantially the same as the second shadow mask SM2, the third shadow mask SM3 and the fourth shadow mask SM4 of the embodiment of FIGS. 10A-10B. Thus, except that the third shadow mask SM3 is used in the exposure process of the display substrate 101 and the fourth shadow mask SM4 is used in the exposure process of the opposite substrate 201, repetitive explanations will be omitted.

In the embodiment of FIGS. 13A-13B, a plurality of alignment directions are formed on each of the sub-pixel areas of the light reactivity polymer film 181. For example, each of the sub-pixel areas of the light reactivity polymer film 181 is photoalignment processed in the column direction, two times by two times.

In addition, the light reactivity polymer film 281 of the opposite substrate is photoalignment processed in the row direction, two times by two times.

Here, since the processes using the third shadow mask SM3 to form a lower alignment layer 180 is substantially the same as the photoalignment processes forming the lower alignment layer 180 of the embodiment of FIGS. 10A-10B, repetitive explanations will be omitted.

Referring to FIG. 13A, the unit pixel area PA is third exposed using the fourth transmission area 54 of the fourth shadow mask SM4.

For example, the fourth transmission area 54 of the fourth shadow mask SM4 is disposed to correspond to the third sub-pixel area SPA21 and the fourth sub-pixel area SPA22. The other sub-pixel areas, that is, the first sub-pixel area SPA11 and the second sub-pixel area SPA12 are blocked by the other parts of the fourth shadow mask SM4.

Here, the third UV light (UV33) is irradiated onto the light reactivity polymer film 181, so that the light reactivity polymer film 181 has a third pretilt angle direction 486 that is the vector sum of the negative row direction and the negative row direction.

Referring to FIG. 13B, the unit pixel area PA is fourth exposed using the fourth transmission area 54 of the fourth shadow mask SM4.

For example, the fourth transmission area 54 of the fourth shadow mask SM4 is disposed to correspond to the first sub-pixel area SPA11 and the second sub-pixel area SPA12. The other sub-pixel areas, that is, the third sub-pixel area SPA21 and the fourth sub-pixel area SPA22 are blocked by the other parts of the fourth shadow mask SM4.

Here, the fourth UV light (UV34) is irradiated onto the light reactivity polymer film 181, so that the light reactivity polymer film 181 has a fourth pretilt angle direction 488 that is the vector sum of the negative row direction and the positive row direction.

Since fifth exposing the boundary between the sub-pixel areas SPA11, SPA12, SPA21 and SPA22 of the unit pixel area PA using the second transmission area 52 of the second shadow mask SM2 is substantially the same as the process shown in FIG. 8E, a repeated explanation will be omitted.

Since the display substrate 101 is opposed to substrate 201, the exposure processes of FIGS. 13A and 13B and the exposure process of the opposite substrate 201 correspond to the exposure processes of FIGS. 11D and 11C and the exposure process of the display substrate 101.

The display substrate 101 is combined with the opposite substrate 201, and the liquid crystal is injected between the display substrate 101 and the opposite substrate 201 to form the liquid crystal layer 301, to manufacture the LCD device 100. As a result, the lower alignment direction of the display substrate 101 and the upper alignment direction of the opposite substrate 201 are vector-summed, and the combination alignment direction of the LCD device is substantially the same as the embodiment of FIGS. 10A-10B.

FIG. 14 is a plan view illustrating the combination alignment directions formed by the alignment direction of the lower alignment layer and the upper alignment layer.

Referring to FIG. 14, pretilt angles having opposite directions in a column direction are formed on each of the sub-pixel areas SPA11, SPA12, SPA21 and SPA22 of the light reactivity polymer film 181 by the first exposure process and the second exposure process, to form the lower alignment layer 180.

Likewise, as shown in FIG. 14, pretilt angles having opposite directions in a row direction formed on each of the sub-pixel areas SPA11, SPA12, SPA21 and SPA22 of the light reactivity polymer film 281 by the first exposure process and the second exposure process, to form the upper alignment layer 280

Here, since the opposite substrate 201 is combined with the display substrate 101, the third pretilt angle direction 486 and the fourth pretilt angle direction 488 reverse to become a third pretilt angle half direction 486′ and a fourth pretilt angle half direction 488′.

Though not shown in FIG. 14, the vertical alignment direction may be formed on the boundary B between the sub-pixel areas SPA11, SPA12, SPA21 and SPA22 of the light reactivity polymer film 181 by the fifth exposure process.

When the liquid crystal molecules of the liquid crystal layer 301 are disposed on the lower alignment layer 180, the liquid crystal molecules pretilt in the first pretilt angle direction 382 and the second pretilt angle direction 384, the pretilt angle direction of the column direction.

Alternatively, when the liquid crystal molecules of the liquid crystal layer 301 are disposed on the upper alignment layer 280, the liquid crystal molecules pretilt in the third pretilt angle half direction 486′ and the fourth pretilt angle half direction 488′, the pretilt angle direction of the row direction.

That is, the combination direction the liquid crystal molecules may be represented as the first combination alignment direction A21, the second combination alignment direction A22, the third combination alignment direction A23, and the fourth combination alignment direction A24, namely, the vector sum of the alignment directions of the lower alignment layer 180 and the alignment directions of the upper alignment layer 280.

Here, the first combination alignment direction A21 to the fourth combination alignment direction A24 rotate in a left-hand direction.

Alternatively, the first combination alignment direction A21 to the fourth combination alignment direction may be formed as one pair converging toward the center portion of the pixel electrode 170 and another pair diverging from the center portion of the pixel electrode 170.

According to the embodiment if FIGS. 13A-13B of the present invention, UV light may be irradiated onto the light reactivity polymer film 181 of the display substrate 101 in a column direction. In addition, UV light may be irradiated onto the light reactivity polymer film 281 of the opposite substrate 201 in a row direction. Because the irradiated directions are simple, the exposure process may be simplified.

In addition, the lower alignment layer 180 of the display substrate 101 and the upper alignment layer 280 of the opposite substrate 201 are photoaligned respectively and vector-summed, to form the first combination alignment direction A21 to the fourth combination alignment direction A24. Accordingly, the lower alignment layer 180 of the display substrate 101 and each of the alignment directions of the upper alignment layer 280 of the opposite substrate 201 may be more correctly formed.

According to embodiments of the present invention, insulation protrusions are formed below a pixel electrode corresponding to a sub-pixel area boundary of a display substrate, to reduce textures that may be generated at the boundary. In addition, vertical light is irradiated onto the boundary, to reduce textures. Accordingly, the display quality of an LCD device may be improved.

The foregoing is illustrative of the embodiments of the present invention and is not to be construed as limiting thereof. Although a few exemplary embodiments of the present invention have been described, those skilled in the art will readily appreciate that many modifications are possible in the exemplary embodiments without materially departing from the novel teachings of the embodiments of the present invention. Accordingly, all such modifications are intended to be included within the scope of the embodiments of the present invention as defined in the appended claims.

What is claimed is:

1. A display substrate comprising:
a lower base substrate comprising a plurality of unit pixel areas defined thereon, each of the unit pixel areas divided into a plurality of sub-pixel areas arranged in a matrix pattern;
an organic insulation layer formed on the lower base substrate;
an insulation protrusion formed on the organic insulation layer that corresponds to a boundary of the sub-pixel areas;
a pixel electrode formed on the organic insulation layer and the insulation protrude; and
a lower alignment layer formed on the pixel electrode having different alignment directions formed by ultraviolet (UV) light irradiation that correspond to the sub-pixel areas of the unit pixel areas.

2. The display substrate of claim 1, wherein the organic insulation layer comprises a photoresist or a color filter.

3. The display substrate of claim 1, wherein the insulation protrusion comprises an insulation material identical to a material of the organic insulation layer or an insulation material that is identical to a material of a light-blocking member or a material of a column spacer.

4. The display substrate of claim 1, wherein the alignment direction of polymer chains of a surface of the lower alignment layer are inclined within each of the sub-pixel areas when viewed from a plan view.

5. The display substrate of claim 4, further comprising gate lines and data lines electrically connected to the pixel electrodes,
wherein the alignment directions of adjacent sub-pixel areas form, respectively, a positive 45° angle, a negative 45° angle, a positive 135° angle and a negative 135° angle with respect to the gate line.

6. The display substrate of claim 5, wherein the alignment directions of the adjacent sub-pixel areas converge to a center portion of the pixel electrode when viewed from a plan view.

7. The display substrate of claim 5, wherein the alignment directions of the adjacent sub-pixel areas comprise one pair that converges to a center portion of the pixel electrode and another pair that diverges from a center portion of the pixel electrode when viewed from a plan view.

8. The display substrate of claim 1, wherein the alignment directions of the sub-pixel areas rotate in a right-hand direction or a left-hand direction when viewed from a plan view.

9. A liquid crystal display (LCD) device comprising:
a display substrate comprising a lower base substrate having a defined plurality of unit pixel areas with each of the plurality of unit pixel areas divided into a plurality of sub-pixel areas arranged in a matrix pattern and an organic insulation layer having an insulation protrusion that corresponds to a boundary of the sub-pixel areas;
an opposite substrate opposed to the display substrate; and
a liquid crystal layer interposed between the display substrate and the opposite substrate, wherein at least one of the display substrate and the opposite substrate has an alignment direction that is determined by UV light irradiation.

10. The LCD device of claim 9, further comprising a pixel electrode formed on the organic insulation layer wherein the pixel electrode is formed over the whole substrate corresponding to the sub-pixel areas.

11. The LCD device of claim 9, wherein the opposite substrate comprises:
a common electrode; and
an upper alignment layer formed on the common electrode.

12. A method of manufacturing a display substrate, the method comprising:
providing a lower base substrate comprising a defined plurality of unit pixel areas, each of the unit pixel area divided into a plurality of sub-pixel areas arranged in a matrix pattern;
forming an organic insulation layer comprising an insulation protrusion formed corresponding to a boundary between the sub-pixel areas on the lower base substrate;
forming a pixel electrode on the organic insulation layer and the insulation protrusion;
forming a light reactivity polymer film on the pixel electrode; and
irradiating polarized light onto the light reactivity polymer film to provide the sub-pixel areas with different alignment directions with respect to each other.

13. The method of claim 12, wherein forming the organic insulation layer comprises:
forming a photoresist layer on the lower base substrate; and
patterning the photoresist to form the insulation protrusion.

14. The method of claim 12, wherein forming the organic insulation layer comprises:
forming a photoresist layer on the lower base substrate; and
patterning the photoresist to form a color filter.

15. The method of claim 12, wherein forming the organic insulation layer comprises:
forming an organic insulation layer on the lower base substrate; and
forming on the organic insulation layer the insulation protrusion from a different type of organic material than the material of the organic insulation layer.

16. The method of claim 12, wherein irradiating polarized light onto the light reactivity polymer film is performed by providing a shadow mask having a blocking area to block one part of the sub-pixel areas and a transmission area to expose the other part of the sub-pixel areas, and by irradiating the light onto the light reactivity polymer film through the transmission area.

17. The method of claim 16, wherein the transmission area of the shadow mask transmits the light in a row direction parallel to gate lines electrically connected to the pixel electrode.

18. The method of claim 16, wherein the transmission area of the shadow mask transmits the light in a column direction parallel to data lines electrically connected to the pixel electrode.

19. The method of claim 16, wherein the transmission area of the shadow mask transmits the light in an oblique line direction inclined about 45° to gate lines electrically connected to the pixel electrode.

20. The method of claim 16, wherein the transmission area of the shadow mask is formed to correspond to a boundary between the sub-pixel areas, and the light is vertical to an incident surface of the transmission area.
